(19) United States
(12) Patent Application Publication
(10) Pub. No.: US 2007/0099590 A1
(43) Pub. Date: May 3, 2007

(54) Frequency converter

(75) Inventors: Hideyuki Okabe, Tokyo (JP); Yuji Kuwana, Tokyo (JP); Masayuki Kimishima, Tokyo (JP)

Correspondence Address: GREENBLUM & BERNSTEIN, P.L.C., 1950 ROLAND CLARKE PLACE, RESTON, VA, 20191, US

(73) Assignee: ADVANTEST CORPORATION, Tokyo (JP)

(21) Appl. No.: 10/596,790

(22) PCT Filed: Dec. 16, 2004
(86) PCT No.: PCT/JP04/19269

§ 371 Date: Jun. 23, 2006

(30) Foreign Application Priority Data
Dec. 25, 2003 (JP) 2003/430667

(51) Int. Cl. H04B 1/26

(52) U.S. Cl. 455/318

(57) ABSTRACT

The frequency characteristic of a conversion loss is kept generally constant during conversion of a high frequency received signal into an intermediate frequency signal. There is provided a frequency converter including a balanced balun (10) which branches a locally oscillated signal (Lo) into two signals which have the same amplitude and are different from each other in phase by 180 degrees, low-pass filters (12a, 12b) through which the two signals pass, and antiparallel diode pairs (16a, 16b) which respectively mix outputs from the low-pass filters (12a, 12b) with a high frequency received signal (RF) to produce an intermediate frequency signal (IF) The low-pass filters (12a, 12b) exhibit generally constant impedances in the frequency band of the high frequency received signal (RF). Accordingly, the impedances of the anti-parallel diode pairs (16a, 16b) as viewed from an anti-parallel diode connection point (17) are generally constant in the frequency band of the high frequency received signal (RF), with the result that the frequency characteristic of the conversion loss can be kept generally constant.

### TECHNICAL FIELD

The present invention relates to a frequency converter, and more particularly relates to a mixer.

### BACKGROUND ART

Conventionally, as a single balance type harmonic mixer has been known one disclosed in a patent document 1 (Japanese Laid-Open Patent Publication (Kokai) No. 2003-69345), and the principle of an even harmonic mixer using an antiparallel diode pair has been known as described in a non-patent document 1 (MARVIN COHN, JAMES E. DEGENFORD, BURTON A. NEWMAN, “Harmonic Mixing with an Antiparallel Diode Pair”, IEEE Transaction on Microwave Theory and Techniques, August 1975, vol. MTT-23, No. 8, p667-673). The single balance type harmonic mixer uses a balanced balun to branch a locally oscillated signal Lo into two signals which are different from each other in phase by 180 degrees, and have the same amplitude, and respectively supplies antiparallel diode pairs with the resulting signals. The antiparallel diode pairs are also supplied with a high frequency received signal RF. The locally oscillated signals Lo and the high frequency received signal RF are mixed by the antiparallel diode pairs, resulting in intermediate frequency signals IF.

The frequency fIF of the intermediate frequency signal IF is represented as:
fIF=fRF−2N·fLo or
fIF=fLo−2N·fRF,
where fLo denotes the frequency of the locally oscillated signal Lo, and fRF denotes the frequency of the high frequency received signal RF. It should be noted that N denotes a positive integer (1, 2, 3, . . . ).

The single balance type harmonic mixer provides such an advantage that the locally oscillated signal Lo and harmonics thereof do not leak to the input side of the high frequency received signal RF.

However, in the above-mentioned single balance type harmonic mixer, the impedance of the output terminal of the balanced balun is the impedance of a terminal of the antiparallel diode pairs connected to the balanced balun. Moreover, the balanced balun is designed to adapt to the band of the fLo, and it is difficult to design it to adapt to the band of fRF. As a result, the impedance of the output terminal of the balanced balun largely changes. Thus, a frequency characteristic of a conversion loss on the conversion of the high frequency received signal RF into the intermediate frequency signal IF largely changes according to the frequency fRF of the high frequency received signal RF. The frequency characteristic of the conversion loss is preferably constant, and the large change of the frequency characteristic of the conversion loss thus poses a problem.

The object of the present invention is to maintain the frequency characteristic of the conversion loss to generally constant on the conversion of the high frequency received signal into the intermediate frequency signal.

### DISCLOSURE OF INVENTION

According to an aspect of the present invention, a frequency converter includes: a signal branching unit that branches a locally oscillated signal into two signals; a constant impedance element that passes the two signals; and a mixing unit that respectively mixes an output from the constant impedance element with a high frequency received signal and generates an intermediate frequency signal, wherein the constant impedance element have a generally constant impedance in a frequency band of the high frequency received signal.

According to the thus constructed frequency converter, a signal branching unit branches a locally oscillated signal into two signals. A constant impedance element passes the two signals. A mixing unit respectively mixes an output from the constant impedance element with a high frequency received signal and generates an intermediate frequency signal. The constant impedance element have a generally constant impedance in a frequency band of the high frequency received signal.

According to the thus constructed frequency converter, the two signals may be two signals that are different from each other in phase by 180 degrees, and have the same amplitudes.

According to the thus constructed frequency converter, an impedance of the constant impedance element may be generally 0Ω across almost an entire frequency band of the high frequency received signal.

According to the thus constructed frequency converter, the constant impedance element may pass a signal with a frequency within the frequency band of the respective two signals more than a signal within the frequency band of the high frequency received signal.

According to the thus constructed frequency converter, the constant impedance element may be a low-pass filter whose cut-off frequency is an upper limit of the frequency band of the two signals.

According to the thus constructed frequency converter, the constant impedance element may be a band-pass filter whose passband is the frequency band of the two signals.

According to the thus constructed frequency converter, the constant impedance element may be a diplexer whose passband is the frequency band of the two signals, and which presents a termination characteristic in the frequency band of the high frequency received signal.

According to the thus constructed frequency converter, the signal branching unit may be a balanced balun corresponding to the frequency band of the locally oscillated signal.

According to the thus constructed frequency converter, the mixing unit may include: one diode; the other diode which is connected at the anode to the cathode of said one diode, and at the cathode to the anode of said one diode; a first terminal to which the cathode of said one diode and the anode of said the other diode are connected; and a second terminal to which the cathode of said the other diode and the anode of said one diode are connected; the first terminal receives an output from the constant impedance element; the second terminal receives the high frequency received signal; and the second terminal outputs the intermediate frequency signal.

The thus constructed frequency converter may further include: a high frequency input terminal which is connected to the second terminal, and receives an input of the high frequency received signal; an intermediate frequency band filter which is connected to the second terminal, and passes a signal within the frequency band of the intermediate frequency signal; and an intermediate frequency signal output terminal which is connected to the intermediate frequency band filter.

### BRIEF DESCRIPTION OF THE DRAWINGS

FIG. 1 is a circuit diagram showing a configuration of a frequency converter 1 according to a first embodiment of the present invention;

FIG. 2 is a chart showing an impedance characteristic of low-pass filters (constant impedance elements) 12a and 12b;

FIG. 3 is a diagram showing an example of a circuit configuration of the low-pass filters 12a and 12b;

FIG. 4 is an impedance chart showing an example of an impedance characteristic of the low-pass filters 12a and 12b;

FIG. 5 is a circuit diagram showing a configuration of a frequency converter 1 according to a second embodiment of the present invention;

FIG. 6 is a chart showing an impedance characteristic of diplexers (constant impedance elements) 22a and 22b; and

FIG. 7 is a circuit diagram showing a circuit configuration of the diplexers 22a and 22b, wherein FIG. 7(a) shows an example where the diplexers 22a and 22b are constituted by band-pass filters and FIG. 7(b) shows an example where the diplexers 22a and 22b are constituted by circuit elements L, C, and R.

### BEST MODE FOR CARING OUT THE INVENTION

A description will now be given of embodiments of the present invention with reference to drawings.

### First Embodiment

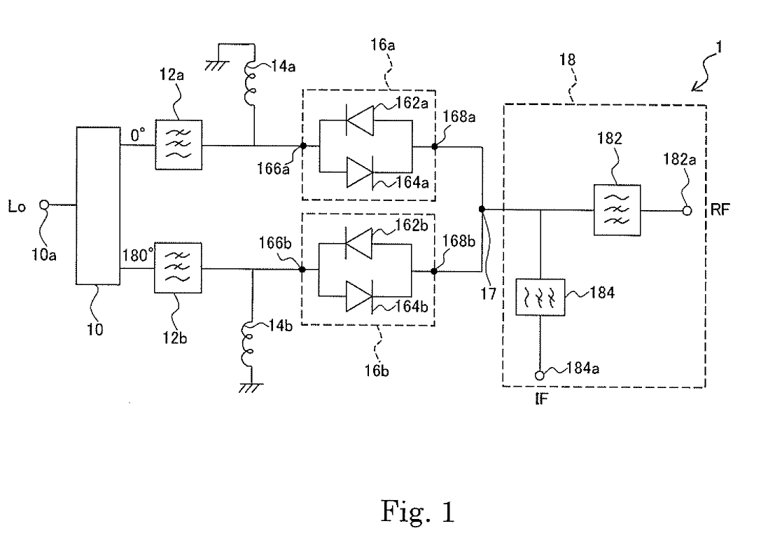

FIG. 1 is a circuit diagram showing a configuration of a frequency converter 1 according to a first embodiment of the present invention. The frequency converter 1 includes a locally oscillated signal input terminal 10a, a balanced balun (signal branching means) 10, low-pass filters (constant impedance elements) 12a and 12b, DC return coils 14a and 14b, antiparallel diode pairs (mixing means) 16a and 16b, an antiparallel diode pair connection point 17, and an RF/IF signal separating unit 18. The frequency converter 1 mixes a locally oscillated signal Lo and a high frequency received signal RF to extract an intermediate frequency signal IF.

The locally oscillated signal input terminal 10a is a terminal which receives an input of a locally oscillated signal Lo (frequency fLo). The locally oscillated signal Lo input to the locally oscillated signal input terminal 10a is supplied to the balanced balun 10. It should be noted that the frequency fLo is 4 to 8 GHz, for example.

The balanced balun (signal branching means) 10 branches the locally oscillated signal Lo into two signals which are different from each other in phase by 180 degrees, and have the same amplitude. The frequency of the two signals is the same as the frequency of the locally oscillated signal Lo. When the phase of one signal is 0°, then the phase of the other signal is 180°(refer to FIG. 1). The balanced balun 10 is designed to adapt to the frequency band (4 to 8 GHz, for example) of the locally oscillated signal Lo. As a result, the impedance largely changes in a frequency band exceeding the frequency band of the locally oscillated signal Lo (the frequency band of the high frequency received signal RF for example).

The low-pass filter (constant impedance element) 12a receives the one signal output from the balanced balun 10. The low-pass filter (constant impedance element) 12b receives the other signal output from the balanced balun 10. The low-pass filters 12a and 12b are low-pass filters whose cut-off frequency is the upper limit of the frequency band of the signals output from the balanced balun 10. It should be noted that the frequency band of the signals output from the balanced balun 10 is the same as the frequency band of the locally oscillated signal Lo. Thus, the upper limit of the frequency band of the signals output from the balanced balun 10 is 8 GHz, and the cut-off frequency is 8 GHz. As a characteristic of the low-pass filter a signal at a frequency equal to or lower than the cut-off frequency (the signal output from the balanced balun 10) is passed more than a signal at a frequency exceeding the cut-off frequency (a signal within the frequency band of the high frequency received signal RF, for example).

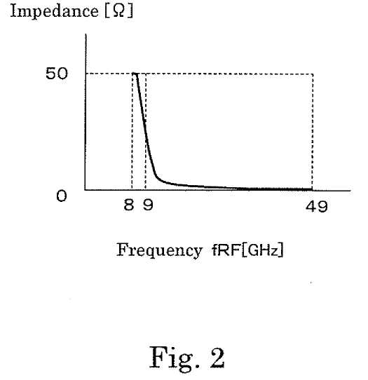

A description will now be given of an impedance characteristic of the low-pass filters (constant impedance elements) 12a and 12b with reference to a chart in FIG. 2. The impedances of the low-pass filters 12a and 12b are generally constant in the frequency band (9 to 49 GHz, for example) of the high frequency received signal RF. Specifically, while the impedance is 50Ω at 8 GHz, the impedance rapidly approaches 0Ω as the frequency increases (the impedance is considerably smaller than 50Ω at 9 GHz, for example), and finally reaches 0Ω. Namely, the impedance is approximately 0Ω across almost the entire frequency band of the high frequency received signal RF.

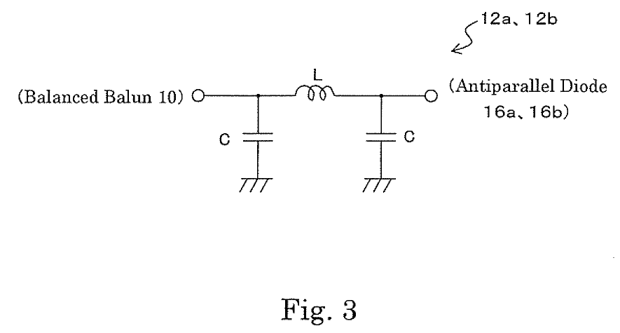

FIG. 3 shows an example of a circuit configuration of the low-pass filters 12a and 12b. The low-pass filters 12a and 12b include a reactance element L which is connected to the balanced balun 10 on one end, and to the antiparallel diode pair 16a or 16b on the other end, a capacitance element C which is connected to the one end of the reactance element L and is grounded, and a capacitance element C which is connected to the other end of the reactance element L and is grounded.

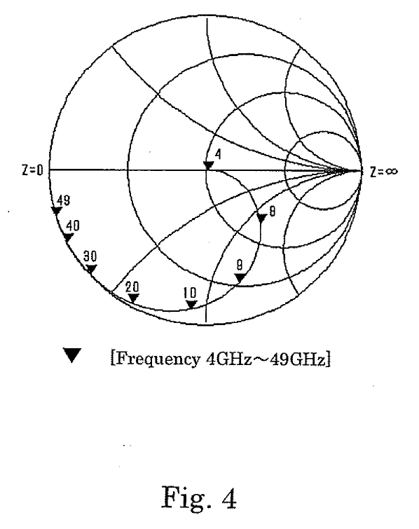

FIG. 4 shows an impedance chart (Smith chart) of the low-pass filters 12a and 12b configured as shown in FIG. 3. With reference to FIG. 4, the impedance is 50Ω at the frequency of 8 GHz, rapidly decreases when the frequency becomes 9 to 10 GHz, and approaches generally 0Ω when the frequency becomes 20 GHz.

The DC return coil 14a is a coil which is connected on one end to an output side (opposite side of the balanced balun 10) of the low-pass filter 12a, and is grounded on the other end. The DC return coil 14b is a coil which is connected on one end to an output side (opposite side of the balanced balun 10) of the low-pass filter 12b, and is grounded on the other end. It should be noted that DC power supplies which supply the antiparallel diode pairs 16a and 16b with desired DC voltages may be connected in place of the DC return coils 14a and 14b.

The antiparallel diode pair (mixing means) 16a includes diodes 162a and 164a, a first terminal 166a, and a second terminal 168a. The diode 162a is connected to the RF/IF signal separating unit 18 at the anode, and is connected to the low-pass filter 12a at the cathode. The diode 164a is a diode which is connected at the anode to the cathode of the diode 162a, and is connected at the cathode to the anode of the diode 162a. The first terminal 166a is a terminal to which the cathode of the diode 162a and the anode of the diode 164a are connected. The second terminal 168a is a terminal to which the cathode of the diode 164a and the anode of the diode 162a are connected.

To the first terminal 166a is input the output from the low-pass filter 12a. To the second terminal 168a is input the high frequency received signal RF. From the second terminal 168a is output the intermediate frequency signal IF.

The antiparallel diode pair (mixing means) 16b includes diodes 162b and 164b, a first terminal 166b, and a second terminal 168b. The diode 162b is connected to the RF/IF signal separating unit 18 at the anode, and is connected to the low-pass filter 12b at the cathode. The diode 164b is a diode which is connected at the anode to the cathode of the diode 162b, and is connected at the cathode to the anode of the diode 162b. The first terminal 166b is a terminal to which the cathode of the diode 162b and the anode of the diode 164b are connected. The second terminal 168b is a terminal to which the cathode of the diode 164b and the anode of the diode 162b are connected.

To the first terminal 166b is input the output from the low-pass filter 12b. To the second terminal 168b is input the high frequency received signal RF From the second terminal 168b is output the intermediate frequency signal IF.

The antiparallel diode pair connection point 17 is a connection point to which the second terminals 168a and 168b and the RF/IF signal separating unit 18 are connected.

The RF/IF signal separating unit 18 receives the high frequency received signal RF, and outputs the high frequency received signal RF to the second terminals 168a and 168b. Then, the RF/IF signal separating unit 18 receives the intermediate frequency signals IF from the second terminals 168a and 168b, and extracts the intermediate frequency signal IF.

The RF/IF signal separating unit 18 includes a high frequency band filter 182, a high frequency input terminal 182a, an intermediate frequency band filter 184, and an intermediate frequency signal terminal 184a.

The high frequency band filter 182 is connected to the second terminals 168a and 168b. The high frequency band filter 182 is a filter which passes a signal in the frequency band (9 to 49 GHz, for example) of the high frequency received signal RF. It should be noted that the high frequency band filter 182 passes a signal at the frequency fIF (1 GHz, for example) of the intermediate frequency signal IF less than a signal in the frequency band of the high frequency received signal RF (preferably cuts off the signal at the frequency fIF).

The high frequency input terminal 182a is connected to the second terminals 168a and 168b via the high frequency band filter 182. The high frequency input terminal 182a receives the input of the high frequency received signal RF.

The intermediate frequency band filter 184 is connected to the second terminals 168a and 168b. The intermediate frequency band filter 184 is a filter which passes a signal at the frequency fIF (1 GHz, for example) of the intermediate frequency signal IF. It should be noted that the intermediate frequency band filter 184 passes a signal in the frequency band (9 to 49 GHz, for example) of the high frequency received signal RF less than a signal at the frequency fIF (1 GHz, for example) of the intermediate frequency signal IF (preferably cuts off the signal in the frequency band of the high frequency received signal RF).

The intermediate frequency signal output terminal 184a is connected to the second terminals 168a and 168b via the intermediate frequency band filter 184. The intermediate frequency signal output terminal 184a is a terminal which outputs the intermediate frequency signal IF.

A description will now be given of an operation of the first embodiment.

To the locally oscillated signal input terminal 10a is input the locally oscillated signal Lo (frequency fLo). It should be noted that the frequency fLo is 4 to 8 GHz, for example. The locally oscillated signal Lo is branched by the balanced balun 10 into the two signals which are different from each other in phase by 180 degrees, and have the same amplitude. These two signals respectively pass the low-pass filters 12a and 12b, and supplied to the first terminals 166a and 166b of the antiparallel diode pairs 16a and 16b.

Moreover, to the high frequency input terminal 182a of the RF/IF signal separating unit 18 is input the high frequency received signal RF (frequency fRF). The high frequency received signal RF passes through the high frequency band filter 182, and is supplied to the second terminals 168a and 168b.

The antiparallel diode pairs 16a and 16b respectively mix even harmonics of the two signals (frequency fLo) which have passed the low-pass filters 12a and 12b and the high frequency received signal RF (frequency fRF) with each other. As a result, there are obtained the intermediate frequency signals IF (frequency fIF).

It should be noted that:
fIF=fRF−2N·fLo,
or
fIF=fLo−2N·fRF,
where N denotes a positive integer (1, 2, 3, . . . ).

Moreover, when the frequency fLo=4 to 8 GHz, the frequency fRF=9 to 49 GHz, and there is obtained the signal fIF=fRF−2N·fLo, the frequency fIF=1 GHz.

Namely,
fIF=fRF−2·fLo(fRF=9 to 17 GHz),
fIF=fRF−4·fLo(fRF=17 to 33 GHz), and
fIF=fRF−6·fLo(fRF=25 to 49 GHz).

On this occasion, since the balanced balun 10 respectively supplies the antiparallel diode pairs 16a and 16b with the two signal which are different from each other in the phase by 180 degrees, and have the same amplitude, odd harmonics (2N−1)·fLo (N is a positive integer) of harmonics generated by the antiparallel diode pairs 16a and 16b cancel each other at the connection point 17.

Moreover, since the direction of the current of the diode 162a (162b) and the direction of the current of the diode 164a (164b) are opposite to each other in the antiparallel diode pair 16a (16b), even harmonics 2N·fLo (N is a positive integer) of the harmonics generated by the antiparallel diode pair 16a (16b) cancel each other at the second terminal 168a (168b).

Consequently, the harmonics of the locally oscillated signal Lo do not leak to the high frequency input terminal 182a.

Moreover, in the antiparallel diode pair 16a (16b), regardless of the phase of the supplied locally oscillated signal Lo, it is considered that either one of the diodes 162a and 164a (162b and 164b) opposite to each other is turned on. As a result, the impedance of the antiparallel diode pair 16a (16b) observed from the antiparallel diode pair connection point 17 is approximately equal to the input/output impedance of the low-pass filter 12a (12b).

The input/output impedance of the low-pass filter 12a (12b) is generally constant in the frequency band (9 to 49 GHz, for example) of the high frequency received signal RF as described above. As a result, the frequency characteristic of the conversion loss upon the high frequency received signal RF being converted into the intermediate frequency signal IF is generally constant even if the frequency RF of the high frequency received signal RF changes.

If there is not the low-pass filter 12a (12b) as a prior art technology the impedance of the antiparallel diode pair 16a (16b) observed from the antiparallel diode pair connection point 17 is approximately equal to the impedance of the balanced balun 10. The impedance of the balanced balun 10 largely changes in the frequency band of the high frequency received signal RF. Thus, the frequency characteristic of the conversion loss on the conversion of the high frequency received signal RF into the intermediate frequency signal IF largely changes as the frequency fRF of the high frequency received signal RF changes.

Moreover, in signal mixing by means of a non-linear element, the efficiency of the mixing generally increases if the impedance beyond the non-linear element observed from a signal input terminal is 0 (short circuit). As a result, since the impedances (impedances of the low-pass filters 12a and 12b) beyond the non-linear elements (antiparallel diode pairs 16a and 16b) observed from the input terminal (antiparallel diode pair connection point 17) of the high frequency received signal RF are generally 0Ω across approximately entire frequency band of the high frequency received signal RF, the efficiency to convert the high frequency received signal RF into the intermediate frequency signal IF increases, resulting in a low loss.

The intermediate frequency signals IF generated by the antiparallel diode pairs 16a and 16b are supplied to the RF/IF signal separating unit 18. The intermediate frequency signals IF cannot pass the high frequency band filter 182, and pass the intermediate frequency band filter 184. The intermediate frequency signal IF is thus output from the intermediate frequency signal output terminal 184a. It should be noted that the high frequency received signal RF which has passed the high frequency band filter 182 cannot pass the intermediate frequency band filter 184, and the high frequency received signal RF will not be mixed with the signal obtained from the intermediate frequency signal output terminal 184a.

According to the first embodiment, the input/output impedance of the low-pass filter 12a (12b) is generally constant in the frequency band (9 to 49 GHz, for example) of the high frequency received signal RF. Thus, the frequency characteristic of the conversion loss on the conversion of the high frequency received signal RF into the intermediate frequency signal IF is generally constant even if the frequency fRF of the high frequency received signal RF changes. Moreover, the efficiency to convert the high frequency received signal RF into the intermediate frequency signal IF increases, resulting in a low loss.

It should be noted that the same effects can be provided when band-pass filters whose passband is the frequency band (4 to 8 GHz, for example) of the signal output from the balanced balun 10 (the impedance characteristic thereof is the same as that of the low-pass filters 12a and 12b (refer to FIG. 2)) are used in place of the low-pass filters 12a and 12b.

### Second Embodiment

The second embodiment includes diplexers 22a and 22b (constant impedance elements) in place of the low-pass filters 12a and 12b according to the first embodiment.

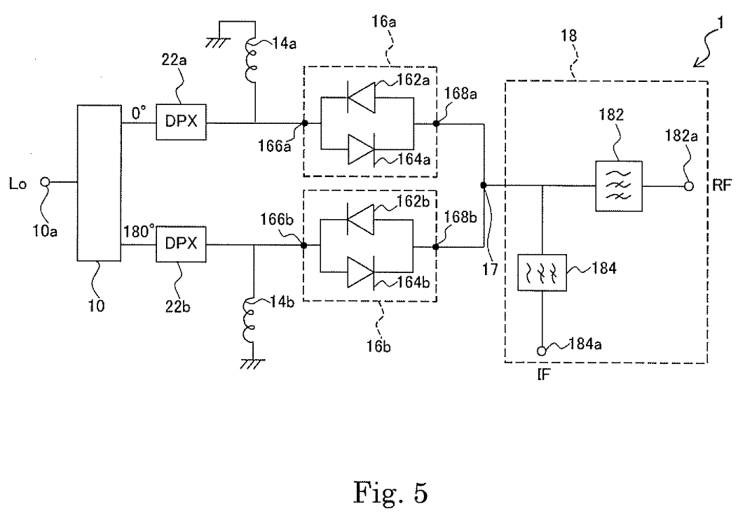

FIG. 5 is a circuit diagram showing a configuration of the frequency converter 1 according the second embodiment of the present invention. The frequency converter 1 includes the locally oscillated signal input terminal 10a, the balanced balun (signal branching means) 10, the diplexers (constant impedance elements) 22a and 22b, the DC return coils 14a and 14b, the antiparallel diode pairs (mixing means) 16a and 16b, the antiparallel diode pair connection point 17, and the RF/IF signal separating unit 18. In the following section, similar components are denoted by the same numerals as of the first embodiment, and will be explained in no more details.

The locally oscillated signal input terminal 10a, the balanced balun (signal branching means) 10, the DC return coils 14a and 14b, the antiparallel diode pairs (mixing means) 16a and 16b, the antiparallel diode pair connection point 17, and the RF/IF signal separating unit 18 are the same as those of the fast embodiment, and a description thereof is thus omitted.

The diplexers (constant impedance elements) 22a and 22b have the frequency band (4 to 8 GHz, for example) of the signal output from the balanced balun 10 as the passband, and exhibit a termination characteristic (have a characteristic as a terminator) in the frequency band (9 to 49 GHz, for example) of the high frequency received signal RF.

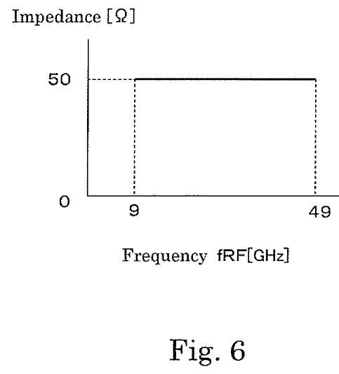

A description will now be given of the impedance characteristic of the diplexers (constant impedance elements) 22a and 22b with reference to a chart in FIG. 6. The impedances of the diplexers (constant impedance elements) 22a and 22b are generally constant at 50Ω in the frequency band (9 to 49 GHz, for example) of the high frequency received signal RF.

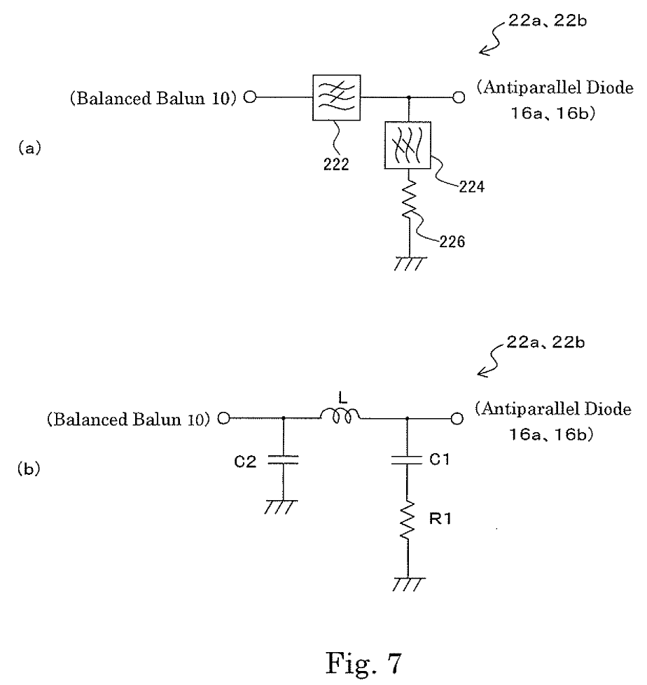

FIG. 7 shows examples of a circuit configuration of the diplexers 22a and 22b.

FIG. 7(a) shows an example where the diplexers 22a and 22b are constituted by band-pass filters. The diplexers 22a and 22b include a band-pass filter 222 which is connected to the balanced balun 10 on one end, and to the antiparallel diode pair 16a or 16b on the other end, a band-pass filter 224 which is connected to the other end of the band-pass filter, and a resistor 226 which is connected to the band-pass filter 224 and is grounded. It should be noted that the band-pass filter 222 has the frequency band (4 to 8 GHz, for example) of the signal output from the balanced balun 10 as the passband. Moreover, the band-pass filter 222 has the frequency band (9 to 49 GHz, for example) of the high frequency received signal RF as the passband.

FIG. 7(b) shows an example where the diplexers 22a and 22b are constituted by circuit elements L, C, and R. The diplexers 22a and 22b include a reactance element L which is connected to the balanced balun 10 on one end, and to the antiparallel diode pair 16a or 16b on the other end, a capacitance element C2 which is connected to the one end of the reactance element L and is grounded, and a capacitance element C1 which is connected to the other end of the reactance element L, and a resistance element R1 which is connected to the capacitance element C1 and is grounded.

An operation of the second embodiment is generally the same as that of the first embodiment.

It should be noted that, in the antiparallel diode pair 16a (16b), regardless of the phase of the supplied locally oscillated signal Lo, it is considered that either one of the diodes 162a and 164a (162b and 164b) opposite to each other is turned on. As a result, the impedance of the antiparallel diode pair 16a (16b) observed from the antiparallel diode pair connection point 17 is approximately equal to the input/output impedance of the diplexer 22a (22b).

The input/output impedance of the diplexer 22a (22b) is generally constant in the frequency band (9 to 49 GHz, for example) of the high frequency received signal RF as described above. Thus, the frequency characteristic of the conversion loss on the conversion of the high frequency received signal RF into the intermediate frequency signal IF is generally constant even if the frequency fRF of the high frequency received signal RF changes.

According to the second embodiment, the input/output impedance of the diplexer 22a (22b) is generally constant in the frequency band (9 to 49 GHz, for example) of the high frequency received signal RF. Thus, the frequency characteristic of the conversion loss on the conversion of the high frequency received signal RF into the intermediate frequency signal IF is generally constant even if the frequency fRF of the high frequency received signal RF changes.

1. A frequency converter comprising:
a signal brancher that branches a locally oscillated signal into two signals;
a constant impedance element that passes the two signals; and
a mixer that respectively mixes an output from said constant impedance element with a high frequency received signal and generates an intermediate frequency signal,
wherein said constant impedance element has a generally constant impedance in a frequency band of the high frequency received signal.

2. The frequency converter according to claim 1, wherein the two signals are two signals that are different from each other in phase by 180 degrees, and have the same amplitudes.

3. The frequency converter according to claim 1, wherein an impedance of said constant impedance element is generally 0Ω across almost an entire frequency band of the high frequency received signal.

4. The frequency converter according to claim 1, wherein said constant impedance element passes a signal with a frequency within the frequency band of the respective two signals more than a signal within the frequency band of the high frequency received signal.

5. The frequency converter according to claim 4, wherein said constant impedance element is a low-pass filter whose cut-off frequency is an upper limit of the frequency band of the two signals.

6. The frequency converter according to claim 4, wherein said constant impedance element is a band-pass filter whose passband is the frequency band of the two signals.

7. The frequency converter according to claim 4, wherein said constant impedance element is a diplexer whose passband is the frequency band of the two signals, and which presents a termination characteristic in the frequency band of the high frequency received signal.

8. The frequency converter according to claim 1, wherein said signal brancher is a balanced balun corresponding to the frequency band of the locally oscillated signal.

9. The frequency converter according to claim 1, wherein:
said mixer comprises:
one diode;
the other diode which is connected at the anode to the cathode of said one diode, and at the cathode to the anode of said one diode;
a first terminal to which the cathode of said one diode and the anode of said the other diode are connected; and
a second terminal to which the cathode of said the other diode and the anode of said one diode are connected;
said first terminal receives an output from said constant impedance element;
said second terminal receives the high frequency received signal; and
said second terminal outputs the intermediate frequency signal.

10. The frequency converter according to claim 9, further comprising:
a high frequency input terminal which is connected to said second terminal, and receives an input of the high frequency received signal;
an intermediate frequency band filter which is connected to said second terminal, and passes a signal within the frequency band of the intermediate frequency signal; and
an intermediate frequency signal output terminal which is connected to said intermediate frequency band filter.
